(19) United States
(12) Patent Application Publication
(10) Pub. No.: US 2016/0108201 A1
(43) Pub. Date: Apr. 21, 2016

(54) INTERNAL MIXTURE FOR A TIRE HAVING IMPROVED CRACKING RESISTANCE

(71) Applicants: MICHELIN RECHERCHE S.A., Granges-Paccot (CH); COMPAGNIE GENERALE DES ETABLISSEMENTS MICHELIN

(72) Inventors: YASUFUMI NAKASHIMA, Tokyo (JP); SALVATORE PAGANO, Clermont-Ferrand (FR)

(21) Appl. No.: 14/893,189

(22) PCT Filed: Apr. 23, 2014
(86) PCT No.: PCT/EP2014/058269

§ 371 Date: Nov. 23, 2015

(30) Foreign Application Priority Data
May 23, 2013 (FR) 1354666

(51) Int. Cl. C08K 3/04; C08K 3/36

(52) U.S. Cl. CPC C08K 3/04; C08K 3/36

(57) ABSTRACT

A tire comprises at least one internal rubber composition having improved cracking resistance, the said internal composition comprising at least 50 to 100 phr of an isoprene elastomer such as natural rubber; optionally, 0 to 50 phr of another diene elastomer such as BR or SBR; 0 to less than 15 phr of a carbon black; between 40 and 100 phr of a nanoscale inorganic filler such as silica. The internal composition is free from or comprises less than 2%, expressed relative to the weight of the nanoscale inorganic filler of (elastomer/inorganic filler) coupling agent.

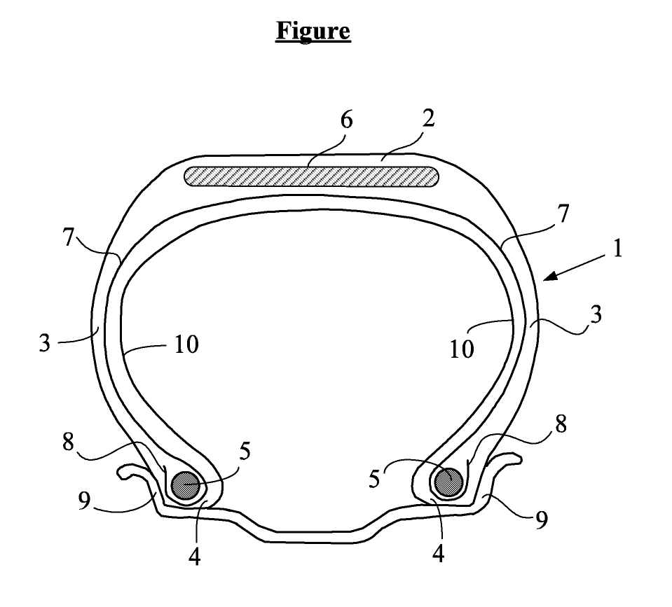

### 1. FIELD OF THE INVENTION

The field of the present invention is that of rubber compositions used as internal mixtures in tyres for vehicles, in particular in the crown reinforcements or “belts” of these tyres.

The present invention relates more particularly to the protection of these internal mixtures from cracking risks which are notably associated with thermal-oxidative ageing, in the belts of tyres with radial carcass reinforcement.

### 2. PRIOR ART

It will be briefly recalled, first of all, that a tyre with radial carcass reinforcement comprises, in a known way, a tread, two non-stretchable beads, two sidewalls connecting the beads to the tread, and a belt arranged circumferentially between the carcass reinforcement and the tread, this belt consisting of various plies (or “layers”) of rubber, which are possibly reinforced by reinforcing elements (or “reinforcers”) such as cords or monofilaments, of the metal or textile type.

The tyre belt generally consists of at least two superimposed belt layers or plies, sometimes called “working” plies or “cross” plies, the reinforcers of which are arranged virtually parallel to one another within a layer, but crossing over from one layer to another, that is to say inclined, symmetrically or asymmetrically, relative to the median circumferential plane, by an angle which is generally between 10° and 45° depending on the type of tyre in question. Each of these crossed layers consists of a rubber matrix generally based on isoprene, sometimes called “calendering rubber”, coating the reinforcers. The crossed layers may be supplemented by various other auxiliary plies or layers of rubber, of varying widths depending on the circumstances, with or without reinforcers; by way of example mention will be made of simple rubber cushions, what are known as “protection” layers with the role of protecting the rest of the belt from external attacks or perforations, or else what are known as “hooping” layers comprising reinforcers oriented substantially in the circumferential direction (what are known as “zero degree” layers), whether they are radially external or internal relative to the crossed layers.

This tyre belt must, in a known way, satisfy numerous, sometimes contradictory, requirements, in particular:
(i) being as stiff as possible with low deformation, since it contributes substantially to stiffening the crown of the tyre;
(ii) having as low a hysteresis as possible, so as on the one hand to minimize rolling heating of the internal zone of the crown, and on the other hand to reduce the rolling resistance of the tyre, which equates to fuel savings;
(iii) finally, having increased endurance, in particular in respect of the phenomenon of separation or cracking of the ends of the crossed layers in the “shoulder” zone of the tyre: this problem is known as “delamination”.

The third condition notably requires the rubber compositions which enter into the constitution of the tyre belts to have very high resistance to crack propagation and to thermal oxidation.

This requirement is particularly stringent for heavy-duty tyre casings, which have been designed, as is known, to be able to be retreaded one or more times when their treads achieve a critical degree of wear after prolonged rolling. It is also stringent generally speaking for any tyre, whether notably of the passenger vehicle type or of the heavy-duty vehicle type, liable to be subjected to particularly harsh rolling conditions in a wet and corrosive atmosphere.

This is why tyre designers are constantly seeking effective and inexpensive solutions enabling improved resistance of rubber vulcanizates to crack propagation, notably due to thermal-oxidative ageing.

### 3. BRIEF DESCRIPTION OF THE INVENTION

During their research, the Applicants have discovered a rubber composition, with a specific formulation, which has improved resistance to crack propagation, thus giving tyres and the internal compositions thereof, notably the belts thereof, improved longevity.

Consequently, the first subject-matter of the invention relates to a tyre comprising an internal rubber composition comprising at least:
50 to 100 phr of an isoprene elastomer;
optionally, 0 to 50 phr of another diene elastomer;
0 to less than 15 phr of a carbon black;
between 40 and 100 phr of a nanoscale inorganic filler,
   this tyre being characterized in that the internal rubber composition is free from or comprises less than 2%, expressed relative to the weight of nanoscale inorganic filler, of (elastomer/inorganic filler) coupling agent.

The invention relates to tyres of all types, pneumatic or non-pneumatic, notably tyres intended to be fitted on passenger type motor vehicles, SUVs (Sports Utility Vehicles), two-wheeled vehicles (notably bicycles, motorcycles), aeroplanes, as well as industrial vehicles chosen from vans, “heavy-duty” vehicles, that is to say underground, bus, heavy road transport vehicles (lorries, tractors, trailers), off-road vehicles such as heavy agricultural vehicles or earthmoving equipment, other transportation or handling vehicles.

The invention and the advantages thereof will be readily understood in the light of the description and the exemplary embodiments which follow, and also of the single FIGURE which relates to these embodiments and which is a schematic radial section of an exemplary tyre with radial carcass reinforcement in accordance with the invention, incorporating an internal composition according to the invention.

### 4. DETAILED DESCRIPTION OF THE INVENTION

In the present description, unless expressly indicated otherwise, all the percentages (%) given are % by weight.

Moreover, any range of values denoted by the expression “between a and b” represents the range of values from more than a to less than b (i.e. limits a and b excluded), while any range of values denoted by the expression “from a to b” means the range of values from a to b (i.e. including the strict limits a and b).

The abbreviation “phr” means parts by weight per hundred parts of elastomer or rubber (of the total of the elastomers if several elastomers are present).

The subject-matter of the invention is therefore a tyre comprising at least one “internal” rubber composition, that is to say by definition, as is known, which is not in contact either with the air or with an inflating gas, the cracking resistance of which is improved and which comprises at least:
50 to 100 phr of an (at least one, that is to say one or more) isoprene elastomer;
optionally, 0 to 50 phr of another (at least one, that is to say one or more) diene elastomer;
0 to less than 15 phr of a (at least one, that is to say one or more) carbon black;
between 40 and 100 phr of a (at least one, that is to say one or more) nanoscale inorganic filler,
   this tyre being characterized in that this internal composition is free from or comprises less than 2%, expressed relative to the weight of nanoscale inorganic filler, of an (elastomer/inorganic filler) coupling agent.

All the constituents above are described in detail hereinafter.

### 4.1. Isoprene Elastomer

The term “diene” elastomer (or rubber, the two terms being taken to be synonymous) is intended to mean generally an elastomer derived at least in part (i.e. a homopolymer or a copolymer) from diene monomers, that is to say monomers bearing two (conjugated or nonconjugated) carbon-carbon double bonds.

With this general definition having been given, in the present patent application “isoprene elastomer” is intended to mean a homopolymer or copolymer of isoprene, in other words a diene elastomer selected from the group consisting of natural rubber (NR), synthetic polyisoprenes (IR), various copolymers of isoprene and mixtures of these elastomers. Among the copolymers of isoprene, mention will in particular be made of isobutene-isoprene copolymers (butyl rubber—IIR), isoprene-styrene copolymers (SIR), isoprene-butadiene copolymers (BIR) or isoprene-butadiene-styrene copolymers (SBIR).

The isoprene elastomer is preferably natural rubber or a synthetic polyisoprene of cis-1,4 type. Among these synthetic polyisoprenes, preference is given to using polyisoprenes having a content (molar %) of cis-1,4 bonds of greater than 90%, in particular greater than 95%, more preferably still greater than 98%.

According to one variant embodiment of the invention, the isoprene elastomer is used alone, that is to say without blending with another diene elastomer. More preferably still, this isoprene elastomer is exclusively natural rubber.

### 4.2. Optional Other Diene Elastomer

According to another variant embodiment of the invention, the isoprene elastomer may be used in a blend, that is to say in a mixture, with a second diene elastomer other than an isoprene elastomer.

Thus, the compositions according to the invention may contain 0 to 50 phr of a second diene elastomer other than this isoprene elastomer, preferably in a minority amount (that is to say at a content of less than 50 phr). The isoprene elastomer more preferably represents 75 to 100% by weight of the total of diene elastomers, namely 75 to 100 phr (parts by weight per hundred parts of elastomer).

By way of diene elastomers other than isoprene elastomers, mention will notably be made of polybutadienes (BR), in particular cis-1,4-polybutadienes or syndiotactic 1,2-polybutadienes and those having a content of 1,2-units of between 4% and 80%, and butadiene copolymers such as styrene-butadiene copolymers (SBR), styrene-butadiene-isoprene copolymers (SBIR) and mixtures of such butadiene homopolymers or copolymers. Mention will notably be made of SBR copolymers having a styrene content between 5% and 50% and more particularly between 20% and 40%, a 1,2 bond content of the butadiene part of between 4% and 65%, and a trans-1,4 bond content of between 30% and 80%.

As examples of internal compositions suitable for the invention, mention will notably be made of compositions comprising, as second diene elastomer, SBR copolymers with a high glass transition temperature (Tg), notably greater than −40° C., for their waterproofing properties, notably in the presence of a lamellar filler (e.g. graphite, talc or mica) (see WO 2011/147710), or for their noise reduction properties in the presence of a hydrocarbon-based plasticizing resin (see WO 2011/147712 or WO 2011/147713), or even SBR with a very high Tg (greater than −10° C.) for their soundproofing properties (see WO 2011/147711).

### 4.3. Carbon Black (Optional)

The internal composition of the tyre of the invention is free from carbon black or comprises less than 15 phr and preferably less than 12 phr thereof. More preferably, between 2 and 10 phr, in particular from 3 to 7 phr, of carbon black are used.

As carbon blacks, all carbon backs conventionally used in tyres (“tyre-grade” blacks) are suitable, such as for example reinforcing carbon blacks from the series 100, 200 or 300 (ASTM grades), or blacks from higher series, in particular 500, 600, 700 or 800 (such as for example the N550, N660, N683, N772, N774 blacks). The carbon blacks might for example be already incorporated in a diene elastomer, notably an isoprene elastomer, in the form of a masterbatch (see for example applications WO 97/36724 or WO 99/16600).

The carbon blacks may be used in the isolated state, as available commercially, or in any other form, for example in a known way as carrier for some of the rubber additives used.

### 4.4. Nanoscale Inorganic Filler

Nanoscale inorganic filler must be understood, in a known way, as any inorganic filler, irrespective of its colour or origin (natural or synthetic), sometimes called “mineral filler”, “white filler”, “light filler” or else “non-black filler”, as opposed to carbon black (which is by definition considered here as an organic filler), which filler is formed from nanoparticles, that is to say particles whose mean size by weight is by definition less than 1 μm, preferably less than 500 nm, in particular between 20 and 200 nm.

Such nanoscale inorganic fillers are well known to those skilled in the art and are capable of reinforcing, in the presence of a coupling agent, rubber compositions for tyres, in other words they are able to replace a conventional tyre-grade carbon black in a reinforcement role; such fillers are generally characterized in a known way by the presence of hydroxyl (—OH) groups at their surface.

Preferably, the content of nanoscale inorganic filler, in particular silica, is between 50 and 100 phr, notably between 50 and 90 phr.

The physical state under which this filler is present is unimportant, whether it be in the form of powder, microbeads, granules, beads or any other suitable densified form.

Mineral fillers of the silica (SiO₂) type are notably suitable. The silica used may be any reinforcing silica known to those skilled in the art, notably any precipitated or fumed silica having a BET specific surface and a CTAB specific surface both of less than 450 m²/g, preferably from 30 to 400 m²/g, notably between 60 and 300 m²/g. Highly dispersible precipitated silicas (called “HDS”) are particularly used, in particular when the invention is used for the manufacture of tyres with low rolling resistance; as examples of such HDS silicas, mention may be made of “Ultrasil” 7000 silicas from Evonik, “Zeosil” 1165 MP, 1135 MP and 1115 MP silicas from Rhodia, “Hi-Sil” EZ150G silica from PPG, “Zeopol” 8715, 8745 or 8755 silicas from Huber, and silicas as described in application WO 03/016387.

By way of other examples of nanoscale inorganic fillers able to be used in the internal compositions according to the invention, mention may also be made of aluminas, aluminium (oxide) hydroxides, aluminosilicates, titanium oxides, silicon carbides or nitrides, all of the reinforcing type in the presence of a coupling agent, as described for example in applications WO 99/28376, WO 00/73372, WO 02/053634, WO 2004/003067 and WO 2004/056915.

The weight-average size may be measured in a well-known way after dispersion by ultrasound deagglomeration of the filler to be analysed in water (or an aqueous solution containing a surfactant), for example by means of an X-ray detection centrifugal sedimentometer of XDC (X-ray disc centrifuge) type, sold by Brookhaven Instruments, according to the following procedure: 3.2 g of sample of inorganic filler to be analysed are suspended in 40 ml of water by the action, over 8 minutes, at 60% power (60% of the maximum position of the “output control”), of a 1500 W ultrasonic probe (Vibracell ¾ inch sonicator sold by Bioblock); after sonication, 15 ml of the suspension are introduced into the rotating disc; after sedimentation for 120 minutes, the distribution by weight of the particle sizes and the weight-average size of the particles d_{w} are calculated by the software of the XDC sedimentometer.

The BET specific surface is determined, in a known way, by gas adsorption using the Brunauer-Emmett-Teller method described in “The Journal of the American Chemical Society”, Vol. 60, page 309, February 1938, more specifically according to French Standard NF ISO 9277 of December 1996 (multipoint (5 points) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

### 4.5. Coupling Agent

As is well known to those skilled in the art, in order to couple a nanoscale inorganic filler to a diene elastomer and to thereby render it reinforcing with regard to the rubber matrix containing it, a coupling agent, also known as a bonding agent, is customarily used, which agent is intended to ensure sufficient chemical and/or physical connection between the filler (surface of the particles thereof) and the diene elastomer.

Such a coupling agent, by definition at least bifunctional, has the simplified general formula “Y-A-X”, in which:
Y represents a functional group (“Y” function) which is capable of physically and/or chemically bonding to the inorganic filler, such a bond being able to be established, for example, between a silicon atom of the coupling agent and the surface hydroxyl (OH) groups of the inorganic filler (for example surface silanols when it is silica);
X represents a functional group (“X” function) which is capable of physically and/or chemically bonding to the diene elastomer, for example via a sulphur atom;
A represents a divalent group allowing Y and X to be linked.

In particular, the coupling agents must not be confused with simple agents for covering the inorganic filler, which in a known way may comprise the “Y” function which is active with regard to the inorganic filler but do not comprise the “X” function which is active with regard to the diene elastomer.

Bifunctional organosilanes or polyorganosiloxanes are customarily used, and most often silane polysulphides, referred to as “symmetrical” or “asymmetrical” depending on their specific structure, such as have been described in a great many patent documents (see, for example, WO 03/002648, WO03/002649 or WO 2004/033548).

As a reminder, the most often used are what are known as “symmetrical” silane polysulphides corresponding to the following general formula (I):

Z-A-Sₓ-A-Z, in which: (I)
x is an integer from 2 to 8 (preferably from 2 to 5);
A is a divalent hydrocarbon-based radical (preferably C₁-C₁₈ alkylene groups or C₆-C₁₂ arylene groups, more particularly C₁-C₁₀ alkylenes, notably C₁-C₄ alkylenes, in particular propylene);
Z corresponds to one of the following formulae:

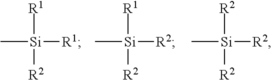

in which:
   the radicals R¹, substituted or unsubstituted, identical to or different from one another, represent a C₁-C₁₈ alkyl group, C₅-C₁₈ cycloalkyl group or C₆-C₁₈ aryl group (preferably C₁-C₆ alkyl, cyclohexyl or phenyl groups, notably C₁-C₄ alkyl groups, more particularly methyl and/or ethyl);
   the radicals R², substituted or unsubstituted, identical to or different from one another, represent a C₁-C₁₈ alkoxy group or C₅-C₁₈ cycloalkoxy group (preferably a group selected from C₁-C₈ alkoxys and C₅-C₈ cycloalkoxys, more preferably still a group selected from C₁-C₄ alkoxys, in particular methoxy and ethoxy).

By way of examples of silane polysulphides, mention will more particularly be made of bis(3-trimethoxysilylpropyl)polysulphides or bis(3-triethoxysilylpropyl)polysulphides. Among these compounds, in particular bis(3-triethoxysilylpropyl)tetrasulphide, abbreviated to TESPT, or bis(triethoxysilylpropyl)disulphide, abbreviated to TESPD, is used. Mention will also be made, as other possible examples, of bis(mono(C₁-C₄)alkoxydi(C₁-C₄)alkylsilylpropyl)polysulphides (notably disulphides, trisulphides or tetrasulphides), for example bis(monoethoxydimethylsilylpropyl)tetrasulphide as described in patent application WO 02/083782 (or US 2004/132880).

By way of coupling agents other than alkoxysilane polysulphides, mention will notably be made of bifunctional POS (polyorganosiloxanes) or else hydroxysilane polysulphides (with R² being OH in the formula (I) above) as described in patent applications WO 02/30939 and WO 02/31041, or else silanes or POS bearing azodicarbonyl functional groups, as described for example in patent applications WO 2006/125532, WO 2006/125533 and WO 2006/125534.

The internal rubber composition of the tyre of the invention has the essential feature of being free from (elastomer/inorganic filler) coupling agent or of comprising a very low amount thereof, namely less than 2% relative to the weight of nanoscale inorganic filler.

In other words, despite its high content (greater than 40 phr) and its nanoscale particle size conferring a reinforcing potential upon it in the presence of a sufficient content (greater than 2%, preferably greater than 5%) of a coupling agent, the nanoscale inorganic filler is not used in the internal composition of the invention as an inorganic filler of the reinforcing type; contrary to the teaching of the prior art, it is used as a specific inert filler, of the nanoscale type in this case.

It is under these conditions that improved protection of the internal compositions from crack propagation after thermal-oxidative ageing has been unexpectedly observed.

For this reason, the content of coupling agent is preferably less than 1%, more preferably less than 0.5%, relative to the weight of nanoscale inorganic filler. More preferably still, the internal composition of the tyre of the invention is completely free from coupling agent.

### 4.6. Various Additives

The composition according to the invention may also comprise all or some of the normal additives customarily used in rubber compositions for tyres, such as for example protection agents such as chemical antiozonants or antioxidants, plasticizers or extending oils, whether the latter are of aromatic or non-aromatic nature, notably oils which are very mildly or not aromatic, for example of the naphthenic or paraffinic type, with high or preferably low viscosity, MES or TDAE oils, hydrocarbon-based plasticizing resins with a high Tg, processing aids for compositions in the raw state, tackifying resins, reinforcing resins (such as resorcinol or bismaleimide), methylene acceptors or donors such as hexamethylenetetramine or hexamethoxymethylmelamine, a crosslinking system based either on sulphur or on sulphur donors and/or on peroxide and/or on bismaleimides, vulcanization accelerators, vulcanization activators, known adhesion-promoting systems of the metal salt type, for example salts (e.g. acetylacetonates, abietates, naphthenates, tallates) of cobalt, nickel or lanthanides such as neodymium.

### 4.7. Preparation of the Rubber Compositions

The compositions are manufactured in appropriate mixers, using two successive phases of preparation well known to those skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., during which finishing phase the crosslinking system is incorporated.

By way of example, the non-productive phase is conducted in a single thermomechanical step lasting several minutes (for example between 2 and 10 min) during which all the necessary base constituents and other additives, except for the crosslinking or vulcanization system, are introduced into an appropriate mixer, such as a standard internal mixer. After cooling the mixture thus obtained, the vulcanization system is then incorporated into an external mixer such as an open mill, held at low temperature (for example between 30° C. and 100° C.). Everything is then mixed (productive phase) for several minutes (for example between 5 and 15 min).

The final composition thus obtained may then be calendered, for example in the form of a sheet or plaque, or else may be extruded, for example so as to form a rubber profiled element which can be used for the manufacture of a composite or a semi-finished product such as, for example, plies, strips, sublayers, other rubber blocks reinforced or not by textile reinforcers or metal reinforcers, intended to form part of the internal structure of a tyre.

Vulcanization (or curing) may then be conducted in a known way at a temperature generally of between 130° C. and 200° C., preferably under pressure, for a suitable length of time which may vary, for example, between 5 and 90 min as a function notably of the curing temperature, of the vulcanization system adopted and of the vulcanization kinetics of the composition in question.

The invention relates to tyres both in the raw state (that is to say before curing) and in the state referred to as cured or vulcanized (that is to say after curing).

### 5. EXEMPLARY EMBODIMENTS OF THE INVENTION

### 5.1. Tyre According to the Invention

The previously described rubber composition of the invention may be used as an internal mixture for any type of motor vehicle tyre.

The term “interior” or “internal” composition (or mixture) is intended here to mean any rubber part of the tyre which is not open to the outside of the tyre, in other words which is not in contact with the air or with an inflating gas and which is therefore situated in the actual inside of the tyre structure; by way of examples, mention will notably be made of the mixtures present in the bead zone, the carcass reinforcement or the crown reinforcement or belt of the tyre.

In contrast the term “exterior” or “external” composition (or mixture) is intended to mean any rubber part of the tyre which is open to the outside of the tyre, in other words which is in contact with the air or with an inflating gas; for example, mention will be made of the tread, the sidewalls or else the airtight layer of the tyre.

By way of example, the appended FIGURE represents, in a highly schematic way, a radial section of a tyre 1 with radial carcass reinforcement in accordance with the invention, intended for example for a heavy-duty vehicle or a passenger vehicle in this very general representation.

This tyre 1 comprises a crown 2, two sidewalls 3, two beads 4 and a carcass reinforcement 7 extending from one bead to the other. The crown 2, surmounted by a tread (not represented in this schematic FIGURE, for simplicity) is reinforced in a manner known per se by a crown reinforcement or belt 6 consisting for example of at least two superimposed crossed crown plies (“working” crown plies), optionally covered by at least one protection ply or one zero degree hooping crown ply. The carcass reinforcement 7 is wound around the two bead wires 5 in each bead 4, the turn-up 8 of this reinforcement 7 being for example arranged towards the exterior of the tyre 1 which is represented here fitted to its wheel rim 9. The carcass reinforcement 7 consists of at least one ply reinforced by what are known as “radial” cords, that is to say that these cords are arranged virtually parallel to one another and extend from one bead to the other so as to form an angle of between 80° and 90° with the median circumferential plane (plane perpendicular to the axis of rotation of the tyre which is situated halfway between the two beads 4 and passes through the middle of the crown reinforcement 6).

Of course, this tyre 1 also comprises in a known way a layer of rubber or elastomer 10, commonly called airtight rubber or airtight layer, which defines the radially internal face of the tyre and which is intended to protect the carcass ply from the diffusion of air coming from the interior space of the tyre. Advantageously, in particular in the case of a tyre for a heavy-duty vehicle, it may also comprise an intermediate reinforcing elastomer layer (not represented in the FIGURE) which is situated between the carcass ply and the airtight layer. The tyre in accordance with the invention has the essential feature of comprising at least one interior composition according to the invention in its internal structure. This interior composition may for example be an internal part of the bead zone 4 comprising the bead wire 5, may constitute the rubber matrix of a crossed crown ply or of a protection ply of the crown reinforcement or belt 6, or else a ply forming all or part of the carcass reinforcement 7.

According to a particular embodiment of the invention, the rubber composition of the invention may advantageously be used as a calendering composition in crown reinforcements or belts 6 for all types of tyres, for example passenger vehicle tyres, van tyres or heavy-duty vehicle tyres. Preferably, in such a case, the rubber composition of the invention has an E10 modulus in the vulcanized state (i.e. after curing) which is greater than 4 MPa, more preferably between 6 and 20 MPa, for example between 6 and 15 MPa.

However, it may also have an advantageous use in a carcass reinforcement 7 of a tyre for a passenger vehicle or industrial vehicle such as a heavy-duty vehicle; preferably, in such a case, the rubber composition of the invention has, in the vulcanized state, an E10 modulus which is less than 9 MPa, more preferably between 4 and 9 MPa.

### 5.2. Rubber Tests (Ageing and Cracking)

For the requirements of these tests, three rubber compositions (hereinafter denoted C-1, C-2 and C-3) were prepared, the formulation of which is given in Table 1, with the content of the various products being expressed in phr (parts by weight per hundred parts of total elastomer, consisting here of 100 phr of NR). These compositions are for example intended to constitute the calendering rubber of the two superimposed crossed crown plies present in the crown reinforcement 6 of a tyre.

The control composition C-1 essentially comprises, in addition to the elastomer and the reinforcing filler, an antioxidant, stearic acid, zinc oxide, sulphur, a sulphenamide accelerator, a guanidine derivative (DPG), an anti-reversion agent and a cobalt salt for promoting adhesion to a metal reinforcer. Its reinforcing filler consists of carbon black (60 phr) to which is added a small amount (5 phr) of non-bonded silica (that is to say without coupling agent).

The control composition C-2 differs from the preceding composition by a reinforcing filler of different nature: here, the latter is essentially composed of inorganic reinforcing filler (60 phr of silica) intended in a known way, by virtue of its silane coupling agent (5.5 phr, i.e. approximately 9% relative to the weight of inorganic filler), to be bonded to the elastomer and therefore to significantly reinforce (increase the modulus of extension) the rubber composition C-2.

Finally, the composition C-3, the only one in accordance with the invention, differs from the preceding composition C-2 solely by the absence of coupling agent; in other words, the nanoscale inorganic filler (silica) used here is a silica which is not bonded to the diene elastomer (natural rubber) and is therefore not intended to reinforce the rubber composition C-3.

For the manufacture of these compositions, the following process was carried out: the filler, the diene elastomer (NR) and the various other ingredients, except for the vulcanization system, were successively introduced into an internal mixer, the initial vessel temperature of which was around 60° C.; the mixer was thus approximately 70% full (% by volume). Thermomechanical working was then carried out (non-productive phase) in one step lasting approximately 2 to 4 min, until a maximum “dropping” temperature of 165° C. was reached. The mixture thus obtained was recovered and cooled and then sulphur and a sulphenamide-type accelerator were incorporated on an external mixer (homofinisher) at 30° C., with everything being mixed (productive phase) for several minutes.

The compositions thus obtained were then calendered in the form of plaques (2 to 3 mm thick) for measuring their mechanical properties, on the one hand, and then in the form of test specimens for conducting cracking and ageing tests, on the other hand.

The tensile properties and the properties at break, after curing (25 min at 150° C.), have been given in the appended Table 2. They were measured, unless expressly indicated otherwise, according to the ASTM D 412 standard of 1998 (test specimen “C”): the true secant moduli, that is to say with respect to the actual section of the test specimen, at 10%, 100% and 300% elongation, denoted here respectively by E10, E100 and E300 and expressed in MPa, were measured (under standard temperature and moisture conditions according to the ASTM D 1349 standard of 1999) in second elongation (i.e. after an accommodation cycle). The stresses at break (in MPa) and the elongations at break (in %) were also measured.

It is noted that the three compositions have values for modulus and elongation at break which of course vary as a function of the nature of the filler (carbon black or silica) and, when it is silica, according to whether or not the latter is bonded to the elastomer (presence or absence of the silane coupling agent).

It is observed in particular that the use of non-bonded silica (without coupling agent) in the composition C-3 according to the invention gives a large increase in the elongation at break without adversely affecting the stress at break.

However, it was only after accelerated ageing tests and then cracking tests as described hereinafter that the full significance of the invention was revealed.

The rubber compositions of Table 1 were placed, after curing, in an oven under air at a temperature of 77° C., under a relative humidity of 60%, for one to several weeks. Then, first of all, the change in their elongation at break was monitored as a function of this thermal-oxidative ageing.

The results are shown in Table 3. Upon reading these results, it is noted that the elongation at break of the composition according to the invention (C-3) is always greater than that of the other two compositions, on the one hand in the initial state (directly after curing) and on the other hand after accelerated ageing for approximately one to four weeks, irrespective of the duration of ageing imposed. Moreover, it is observed that even the relative loss (expressed in %) of elongation at break after ageing is always less than the other two compositions, irrespective of the duration of the accelerated ageing (see in particular % loss after 27 days of only 43%).

This improved performance of the composition according to the invention in terms of change in elongation at break over the course of the ageing hinted at an increase in the cracking resistance, which was confirmed by complementary cracking tests as described hereinafter.

The rate of cracking was measured on test specimens of the rubber compositions C-1 to C-3, with the aid of a cyclic fatigue machine (“Elastomer Test System”) of the 381 type from MTS, as explained hereinafter.

The cracking resistance was measured with the aid of repeated tensile actions on a test specimen which was initially accommodated (after a first tensile cycle), then notched. The tensile test specimen consisted of a rubber plaque of parallelepipedal shape, for example with a thickness of between 1 and 2 mm, a length of between 130 and 170 mm and a width of between 10 and 15 mm, with the two lateral edges each being covered lengthwise with a cylindrical rubber bead (diameter 5 mm) enabling the specimen to be anchored in the jaws of the tensile testing device. The test specimens thus prepared were tested in the fresh state and after accelerated ageing (as indicated above). The test was conducted under air, at a temperature of 90° C. After accommodation, 3 very narrow notches of between 15 and 20 mm in length were made with the aid of a razor blade, at mid-width and aligned in the lengthwise direction of the test specimen, with one at each end and one at the centre of the latter, before starting the test. With each tensile cycle, the degree of deformation of the test specimen was automatically adjusted so as to hold the energy restitution level (the amount of energy released during crack progression) constant at a value equal to approximately 1000 J/m². The rate of crack propagation was measured and expressed in nanometres per cycle. Of course, a lower value indicates better resistance to crack propagation.

The results are given in the appended Table 4. These results show very clearly, first of all, that the conventional use (that is to say in the presence of a coupling agent) of silica (control composition C-2) instead of carbon black (control composition C-1) already enables the rate of cracking to be very significantly reduced. Such a property of silica compared to carbon black was already known to those skilled in the art and is described for example in application EP 0 722 977 or WO 2004/033548.

However, these results most of all show that, unexpectedly, the use of a high content (in any case greater than 40 phr) of non-bonded silica in the composition C-3 according to the invention enables this rate to be notably further reduced, for example from 2.6-fold in the initial state (from 6.5 to 2.5 nm/cycle) to approximately 7-fold after 27 days of accelerated ageing (from 130 to 18 nm/cycle), compared to the conventional use in the control composition C-2 of one and the same amount of bonded silica, that is to say coupled by means of a coupling agent.

In conclusion, the rubber tests above clearly demonstrate that the use of a high content of inorganic reinforcing filler such as silica in the non-bonded state, that is to say not coupled to the diene elastomer, enables a substantial reduction in the rate of crack or notch propagation, in other words enables an improvement in the tearability properties, thus offering the vulcanizates, and the tyres comprising them, improved longevity due to better protection from the effects of thermal-oxidative ageing.

TABLE 1

| Formulation of the rubber | | | |
|---|---|---|---|
| compositions (in phr): | C-1 | C-2 | C-3 |
| Diene elastomer (1) | 100 | 100 | 100 |
| Carbon black (2) | 60 | 5 | 5 |
| Silica (3) | 5 | 60 | 60 |
| Silane coupling | — | 5.5 | — |
| agent (4) | | | |
| Cobalt compound (5) | 2 | 2 | 2 |
| Antioxidant (6) | 2.5 | 2.5 | 2.5 |
| Stearic acid | 0.2 | 0.2 | 0.2 |
| Zinc oxide | 8 | 8 | 8 |
| Sulphur | 5 | 5 | 5 |
| Sulphenamide | 0.7 | 0.7 | 0.7 |
| accelerator (7) | | | |
| DPG (8) | 1.5 | 1.5 | 1.5 |
| Anti-reversion | 2 | 2 | 2 |
| agent (9) | | | |

(1) Peptized natural rubber (“Aktiplast 8” from Rhein Chemie);
(2) N326 (name according to standard ASTM D-1765) from Cabot;
(3) “Ultrasil 7000” from Evonik, “HDS” type (CTAB and BET: approximately 160 m²/g);
(4) TESPT coupling agent (“Si69” from Evonik);
(5) Cobalt tallate (“Dicnate tallate” from DIC Synthetic Resins Company);
(6) N-(1,3-Dimethylbutyl)-N′-phenyl-p-phenylenediamine; (“Santoflex 6PPD” from Flexsys);
(7) N-tert-Butyl-2-benzothiazolesulphenamide (“Nocceler NS-P” from Ouchi Shinko Chemical Ind. Company);
(8) Diphenylguanidine (“Perkacit DPG” from Flexsys);
(9) Sodium hexamethylenethiosulphate (“Duralink HTS” from Flexsys).

TABLE 2

| | Composition: | | |
|---|---|---|---|
| Properties after curing: | C-1 | C-2 | C-3 |
| E10 (MPa) | 9.5 | 8.0 | 9.5 |
| E100 (MPa) | 4.2 | 3.0 | 2.2 |
| E300 (MPa) | 4.0 | 2.4 | 1.6 |
| Stress at break (MPa) | 26 | 25 | 25 |
| Elongation at break (%) | 300 | 400 | 480 |

TABLE 3

| EB (elongation at break in %): | C-1 | | C-2 | | C-3 | |
|---|---|---|---|---|---|---|
| In the initial state (after | 300 | (100) | 400 | (100) | 480 | (100) |
| curing): | | | | | | |
| After ageing for 7 days: | 225 | (75) | 265 | (66) | 390 | (81) |
| After ageing for 19 days: | 145 | (48) | 185 | (46) | 305 | (69) |
| After ageing for 27 days: | 130 | (43) | 160 | (40) | 275 | (57) |

| | | | |
|---|---|---|---|
| % loss after 27 days: | −57% | −60% | −43% |

TABLE 4

| Rate of cracking (nm/cycle): | C-1 | C-2 | C-3 |
|---|---|---|---|
| In the initial state (after | 50 | 6.5 | 2.5 |
| curing): | | | |
| After ageing for 7 days: | 550 | 8.0 | 3.6 |
| After ageing for 19 days: | 9 000 | 21 | 10 |
| After ageing for 27 days: | 28 000 | 130 | 18 |

1.-11. (canceled)

12. A tire comprising an internal rubber composition, wherein the internal rubber composition comprises at least:
50 to 100 phr of an isoprene elastomer;
0 to 50 phr of another diene elastomer;
0 to less than 15 phr of a carbon black; and
between 40 and 100 phr of a nanoscale inorganic filler, and
wherein the internal rubber composition is free from or comprises less than 2%, expressed relative to the weight of nanoscale inorganic filler, of elastomer/inorganic filler coupling agent.

13. The tire according to claim 12, wherein the another diene elastomer is a polybutadiene or a butadiene copolymer.

14. The tire according to claim 13, wherein the butadiene copolymer is a copolymer based on butadiene and styrene.

15. The tire according to claim 14, wherein the copolymer based on butadiene and styrene is selected from the group consisting of styrene-butadiene copolymers, styrene-butadiene-isoprene copolymers, and mixtures thereof.

16. The tire according to claim 15, wherein the copolymer based on butadiene and styrene is an SBR copolymer.

17. The tire according to claim 12, wherein carbon black is present in an amount of less than 12 phr.

18. The tire according to claim 18, wherein carbon black is present in an amount ranging from 2 to 10 phr.

19. The tire according to claim 12, wherein the nanoscale inorganic filler is a silica.

20. The tire according to claim 12, wherein the content of nanoscale inorganic filler is between 50 and 100 phr.

21. The tire according to claim 20, wherein the content of nanoscale inorganic filler is between 50 and 90 phr.

22. The tire according to claim 12, wherein a content of elastomer/inorganic filler coupling agent is less than 1% relative to the weight of nanoscale inorganic filler.

23. The tire according to claim 22, wherein the content of elastomer/inorganic filler coupling agent is less than 0.5% relative to the weight of nanoscale inorganic filler.

24. The tire according to claim 23, wherein the internal composition is free from coupling agent.

25. The tire according to claim 12, wherein the belt of the tire comprises the internal composition.
